(19) United States
(12) Patent Application Publication
(10) Pub. No.: US 2012/0062464 A1
(43) Pub. Date: Mar. 15, 2012

(54) TOUCH SENSOR

(75) Inventors: Takayasu OTAGAKI, Hashima-shi (JP); Atsuhiro Ichikawa, Mizuho-shi (JP); Hiroya Ito, Ichinomiya-shi (JP)

(73) Assignee: ON Semiconductor Trading, Ltd.

(21) Appl. No.: 13/230,392

(22) Filed: Sep. 12, 2011

(30) Foreign Application Priority Data
Sep. 14, 2010 (JP) 2010-205603

(51) Int. Cl. G06F 3/02

(52) U.S. Cl. 345/168

(57) ABSTRACT

The invention provides a touch sensor in which the numbers of channels and wires are decreased simultaneously and a simultaneous touch operation of a plurality of touch keys is realized. A keyboard includes 36 pieces of touch keys disposed in 6 rows and 6 columns, drive lines, and sensor lines on an insulation substrate. The touch key includes a center electrode disposed on the insulation substrate and an annular electrode disposed surrounding this center electrode. A sensor circuit includes a selection circuit and an electric charge amplifier. The electric charge amplifier detects the amount of change of a capacitance of an electrostatic capacitor formed between the center electrode and the annular electrode of the touch key connected to one sensor line selected by the selection circuit.

### CROSS-REFERENCE OF THE INVENTION

This application claims priority from Japanese Patent Application No. 2010-205603, the content of which is incorporated herein by reference in its entirety.

### BACKGROUND OF THE INVENTION

1. Field of the Invention

The invention relates to a touch sensor, in particular, an electrostatic capacitor type touch sensor that detects a position touched with a human fingertip, a pen point or the like by utilizing a change of an electrostatic capacitance.

2. Description of the Related Art

A touch sensor is known as a data input device for various types of electronic devices such as a cellular phone, a portable audio device, a portable game device, a television, a personal computer and so on. (Refer to the Japanese Patent Application Publication No. 2005-190950 as an example).

In recent years, a touch sensor is widely used, replacing a conventional tact switch. FIG. 11 is a diagram showing a basic structure of a general touch sensor. This touch sensor includes 16 types of touch keys 1 to 16 disposed on a substrate and a sensor circuit with 16 channels corresponding to these touch keys. The sensor circuit detects a change of an electrostatic capacitance that occurs when any one of the touch keys 1 to 16 is touched with a human fingertip, a pen point or the like. In this case, one channel includes a circuit that detects a change of the electrostatic capacitance of the corresponding touch key.

FIG. 12 is a diagram showing a basic structure of a touch sensor in which the number of channels is decreased. In this touch sensor, there are 7 types of touch keys, and one touch key is made by combining two types of touch keys selected from the 7 types of touch keys. For example, one combined touch key 1+2 is made by combining touch keys 1 and 2. In this case, the combined touch key 1+2 detects a change of the electrostatic capacitance by channels 1 and 2. This enables decreasing the number of the channels of the sensor circuit to 7.

A relevant technique is disclosed in the Japanese Patent Application Publication No. 2005-190950.

However, the touch sensor in FIG. 11 needs the same number of the channels as the number of the touch keys, thereby causing a problem that the size of the sensor circuit increases and the cost increases. On the other hand, the touch sensor in FIG. 12 enables decreasing the number of the channels, but there is a problem that the number of wires for connecting the touch keys and the sensor circuit increases and the area of the substrate increases. Furthermore, it is necessary to address crosstalk between the wires caused by the increase of the number of the wires.

In other words, the number of the channels and the number of the wires are in a tradeoff relation. When the number of the channels is increased, the number of the wires is decreased but the cost increases. When the number of the channels is decreased by combining the touch keys, the number of the wires increases and the area of the substrate increases. Therefore, both the numbers can not be decreased simultaneously.

Furthermore, it is impossible to perform a simultaneous touch operation of the combined touch keys in FIG. 12. For example, when the combined touch keys 1+2 and 1+6 are touched simultaneously, the channels 1, 2 and 6 of the sensor circuit detect the changes of the electrostatic capacitors. However, when the combined touch keys 1+6 and 2+6 are touched simultaneously, the channels 1, 2 and 6 of the sensor circuit detect the changes of the electrostatic capacitors, too. Therefore, the sensor circuit can not distinguish these.

### SUMMARY OF THE INVENTION

The invention provides a touch sensor including: a substrate; a plurality of touch keys disposed in a plurality of rows and columns on the substrate and each including a first electrode and a second electrode surrounding the first electrode; a plurality of drive lines disposed on the substrate and each connecting the second electrodes of the plurality of touch keys disposed in a first direction corresponding to each of the plurality of rows; a plurality of sensor lines disposed on the substrate and each connecting the first electrodes of the plurality of touch keys disposed in a second direction corresponding to each of the plurality of columns; a clock source applying a clock signal to the plurality of drive lines in sequence; a selection circuit selecting the plurality of sensor lines in sequence during the application of the clock signal to one of the plurality of drive lines from the clock source; and a detection circuit detecting a change of a capacitance of an electrostatic capacitor formed between the first electrode and the second electrode of the touch key connected to the sensor line selected by the selection circuit.

### BRIEF DESCRIPTION OF THE DRAWINGS

FIG. 1 is a diagram showing a structure of a touch sensor of an embodiment of the invention.

FIG. 2 is a circuit diagram of a sensor circuit of the touch sensor.

FIG. 3 is an operation timing chart of the touch sensor of the embodiment of the invention.

FIG. 4 is a circuit diagram of an electric charge amplifier.

FIGS. 5A and 5B are diagrams for explaining an operation of the electric charge amplifier.

FIGS. 6A, 6B and 6C are schematic views showing electric field states around touch keys.

FIG. 7 is a plan view showing a first example of a disposition of touch keys.

FIG. 8 is a plan view showing a second example of a disposition of touch keys.

FIG. 9 is a plan view showing a third example of a disposition of touch keys.

FIGS. 10A, 10B and 10C are plan views showing examples of structures of touch keys.

FIG. 11 is a diagram showing a structure of a conventional touch sensor.

FIG. 12 is a diagram showing other structure of a conventional touch sensor.

### DETAILED DESCRIPTION OF THE INVENTION

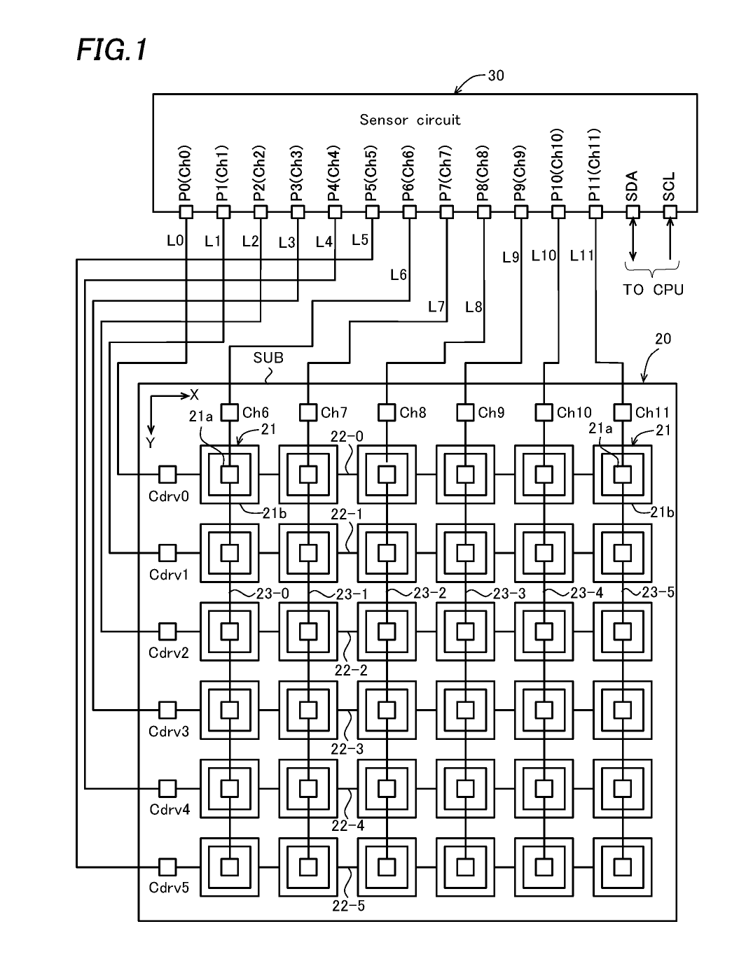

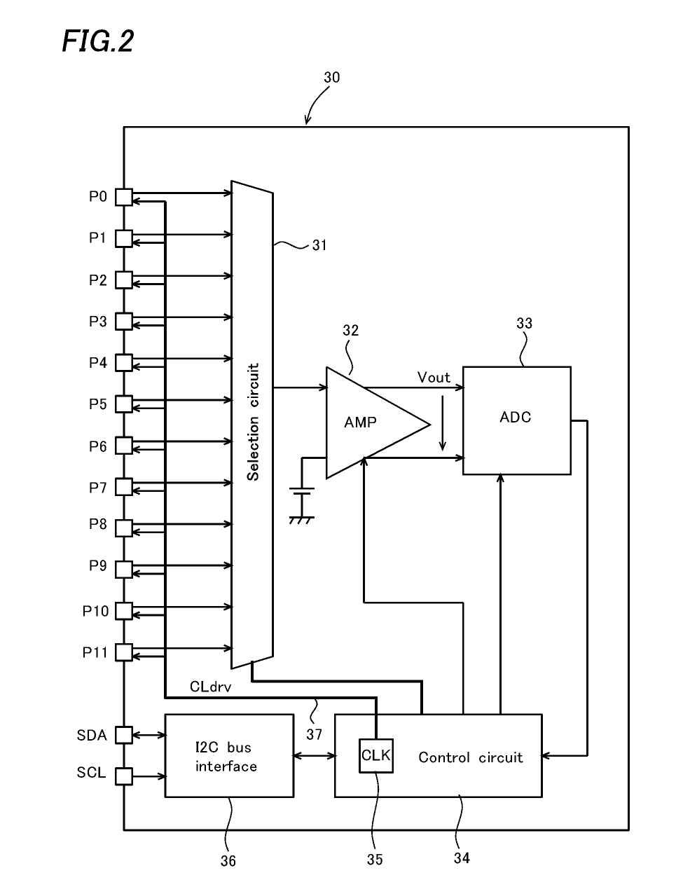

An embodiment of the invention will be described referring to figures. FIG. 1 is a diagram showing a whole structure of a touch sensor of the embodiment of the invention. The touch sensor includes a keyboard 20 (a touch panel) and a sensor circuit 30.

===Structure of Keyboard 20===

A structure of the keyboard 20 will be described first. The keyboard 20 includes an insulation substrate SUB such as a PCB substrate, 36 pieces of touch keys 21 disposed on the front surface of this insulation substrate SUB, drive lines 22-0 to 22-5, and sensor lines 23-0 to 23-5.

The 36 pieces of touch keys 21 are disposed in a matrix of 6 rows by 6 columns. Each of the touch keys 21 includes a center electrode 21a (an example of a “first electrode” of the invention) disposed on the front surface of the insulation substrate SUB and an annular electrode 21b (an example of a “second electrode” of the invention) disposed surrounding this center electrode 21a. The center electrode 21a and the annular electrode 21b are electrically isolated.

The drive lines 22-0 to 22-5 are disposed corresponding to the rows respectively, each of which electrically connects the annular electrodes 21b of the 6 pieces of touch keys 21 disposed in the row direction (in the X direction in FIG. 1). The sensor lines 23-0 to 23-5 are disposed corresponding to the columns respectively, each of which electrically connects the center electrodes 21a of the 6 pieces of touch keys 21 disposed in the column direction (in the Y direction in FIG. 1).

The sensor lines 23-0 to 23-5 and the annular electrodes 21b are electrically isolated. In this case, the center electrodes 21a, the annular electrodes 21b and the drive lines 22-0 to 22-5 are made of a lower wire, and the sensor lines 23-0 to 23-5 are made of an upper wire that is insulated from the lower wire. Alternatively, the annular electrodes 21b and the drive lines 22-0 to 22-5 are made of a lower wire, and the center electrodes 21a and the sensor lines 23-0 to 23-5 are made of an upper wire.

The drive lines 22-0 to 22-5 are connected to terminals P0 to P5 (clock output terminals) of the sensor circuit 30 by external wires L0 to L5 through 6 pieces of corresponding drive terminals Cdrv0 to Cdrv5 disposed on the front surface of the insulation substrate SUB. The sensor lines 23-0 to 23-5 are connected to terminals P6 to P11 (channel input terminals) of the sensor circuit 30 by external wires L6 to L11 through channel terminals Ch6 to Ch11.

An electrostatic capacitor is formed between the center electrode 21a and the annular electrode 21b of the touch key 21, and the capacitance C1 of the electrostatic capacitor changes when a human finger or the like comes close to the touch key 21. As described below, the sensor circuit 30 includes a circuit that converts this change AC of the capacitance C1 to a voltage.

It is preferable to attach a protection board made of a dielectric member such as an acrylic member to the insulation substrate SUB on which the touch keys 21, the drive lines 22-0 to 22-5, the sensor lines 23-0 to 23-5 and so on are formed with an adhesive.

===Structure of Sensor Circuit 30===

The sensor circuit 30 includes terminals P0 to P11, a selection circuit 31, an electric charge amplifier 32 (an example of a “detection circuit” of the invention), an AD converter 33, a control circuit 34, a clock source 35, an I²C bus interface circuit 36 and clock wires 37. The control circuit 34 is a circuit that controls the operation of the whole sensor circuit 30, i.e., the selection circuit 31, the electric charge amplifier 32, the AD converter 33, the clock source 35, the I²C bus interface circuit 36 and so on. The sensor circuit 30 is made of one IC die (a semiconductor integrated circuit).

The terminals P0 to P11 are used as input terminals to which a sensor signal is inputted or output terminals from which a clock signal CLdry is outputted. The clock signal CLdry is a signal that alternates a H level and a L level. In the case of the touch sensor of the embodiment, the terminals P0 to P5 are used as the output terminals of the clock signal CLdrv.

In detail, the clock output terminal of the clock source 35 of the control circuit 34 is connected to the terminals P0 to P11 through the corresponding 12 clock wires 37. In this case, the control circuit 34 makes a control so as to output the clock signal CLdry to the terminals P0 to P5 through the corresponding clock wires 37 in sequence.

The terminals P0 to P5 are connected to the corresponding drive terminals Cdrv0 to Cdrv5 of the keyboard 20 through the external wires L0 to L5 as described above, and thus the clock signal CLdry is applied to the drive lines 22-0 to 22-5 in sequence. The clock signal CLdry is applied only to the drive line 22-0 for a certain period, and applied only to the drive line 22-1 for the next period. (Subsequently, the clock signal CLdry is applied in the same manner.) By this, the clock signal CLdry is applied to the annular electrodes 21b connected to the drive lines 22-0 to 22-5. The application of the clock signal CLdry enables the detection of a capacitance change of the electrostatic capacitor between the center electrode 21a and the annular electrode 21b by the electric charge amplifier 32.

Furthermore, in the case of the touch sensor of the embodiment, the terminals P6 to P11 are used as the input terminals to which the sensor signal is inputted. In detail, as descried above, the sensor lines 23-0 to 23-5 of the keyboard 20 are connected to the terminals P6 to P11 of the sensor circuit 30 through the external wires L6 to L11.

The selection circuit 31 selects the sensor lines 23-0 to 23-5 in sequence during the application of the clock signal CLdry to any one of the drive lines 22-0 to 22-5. In detail, the sensor line 23-0 is selected for a certain period during the application of the clock signal CLdrv, and the sensor line 23-1 is selected for the next period. (Subsequently, selection is performed in the same manner.)

The electric charge amplifier 32 detects the amount of change AC of the capacitance C1 of the electrostatic capacitor formed between the center electrode 21a and annular electrode 21b of the touch key 21 connected to one sensor line 23-k (k=0 to 5) selected by the selection circuit 31, and outputs an output voltage Vout proportional to AC. The electric charge amplifier 32 sequentially outputs an output voltage Vout in the respective periods in which the sensor lines 23-0 to 23-5 are selected in sequence. A concrete structure of the electric charge amplifier 32 will be described below.

The AD converter 33 is a circuit that converts an output voltage Vout of the electric charge amplifier 32 into a digital signal, and preferably, is made of a 16-bit delta/sigma type AD converter, for example. A digital signal outputted from the AD converter 33 is temporarily stored by the control circuit 34, and sent to an external CPU, for example, a microcomputer through the I²C bus interface circuit 36.

In this case, the digital signal is serially outputted from the serial data terminal SDA in synchronization with a serial clock applied to the serial clock terminal SCL from the microcomputer side. The microcomputer judges which one of the touch keys 21 is touched based on the sent digital signal. In this case, the microcomputer judges that the touch key 21 is touched when the digital data is larger than a predetermined threshold, for example.

===Operation of Touch Sensor===

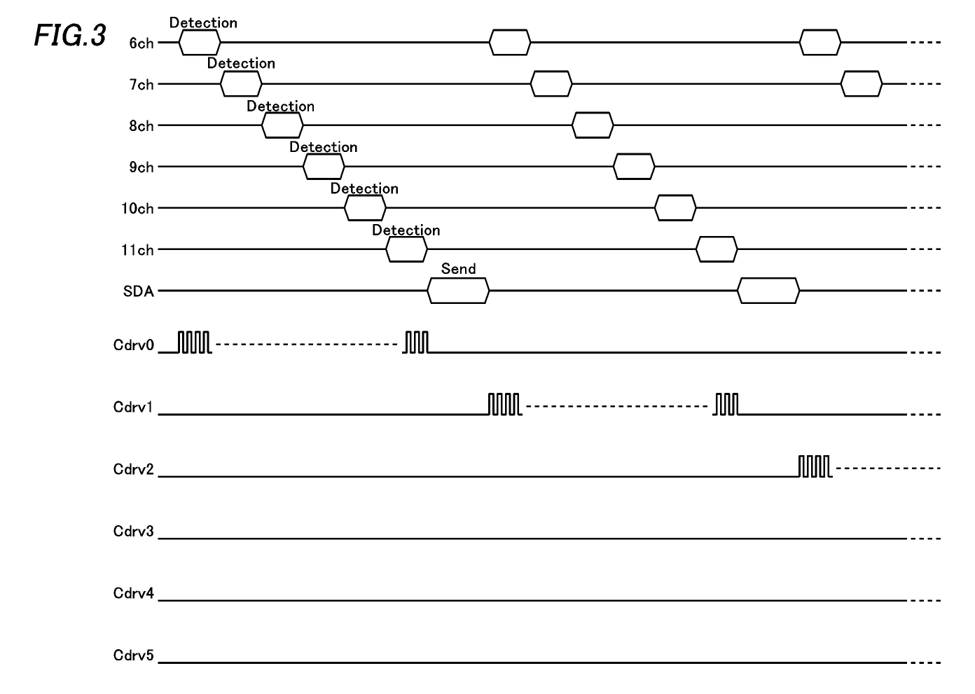

Next, an operation of the touch sensor will be described referring to an operation timing chart in FIG. 3. First, the clock signal CLdry outputted from the clock output terminal P0 of the sensor circuit 30 is applied to the drive line 22-0 in the first row of the keyboard 20 through the drive terminal Cdrv0 for a predetermined period. The selection circuit 31 then selects the sensor lines 23-0 to 23-5 that are connected to the channel terminals Ch6 to Ch11 respectively for this predetermined period in sequence.

In detail, the sensor line 23-0 (the channel terminal Ch6) is selected first. By this, the touch key 21 disposed in the first row and column is selected. Then the electric charge amplifier 32 detects the amount of change AC of the capacitance C1 of the electrostatic capacitor formed between the center electrode 21a and annular electrode 21b of the touch key 21 connected to the sensor line 23-0, and outputs an output voltage Vout proportional to AC. The output voltage Vout is converted into a digital signal by the AD converter 33, and then temporarily stored by the control circuit 34.

Then the sensor line 23-1 (the channel terminal Ch7) is selected. By this, the touch key 21 disposed in the first row and second column is selected. The electric charge amplifier 32 then detects the amount of change AC of the capacitance C1 of the electrostatic capacitor formed between the center electrode 21a and annular electrode 21b of the touch key 21 connected to the sensor line 23-1, and outputs an output voltage Vout proportional to ΔC. The output voltage Vout is converted into a digital signal by the AD converter 33, and then temporarily stored by the control circuit 34.

In this manner, the 6 pieces of touch keys disposed in the first row of the keyboard 20 are selected in sequence, and the detections of the capacitance changes are performed. When the detections of the 6 pieces of touch keys disposed in the first row are completed, the digital signals temporarily stored by the control circuit 34 are sent to the external microcomputer through the I²C bus interface circuit 36 and the serial data terminal SDA.

Then the clock signal CLdry outputted from the clock output terminal P1 of the sensor circuit 30 is applied to the drive line 22-1 in the second row of the keyboard 20 through the drive terminal Cdrv1 for a predetermined period. The selection circuit 31 then selects the sensor lines 23-0 to 23-5 that are connected to the channel terminals Ch6 to Ch11 respectively for this predetermined period in sequence. Then, in the same manner, the 6 pieces of touch keys disposed in the second row of the keyboard 20 are selected in sequence, and the detections of the capacitance changes are performed.

Then the clock signal CLdry outputted from the clock output terminal P2 of the sensor circuit 30 is applied to the drive line 22-2 in the third row of the keyboard 20 through the drive terminal Cdrv2 for a predetermined period. The selection circuit 31 then selects the sensor lines 23-0 to 23-5 that are connected to the channel terminals Ch6 to Ch11 respectively for this predetermined period in sequence.

Then, in the same manner, the 6 pieces of touch keys disposed in the third row of the keyboard 20 are selected in sequence, and the detections of the capacitance changes are performed. Then, in the same manner, the 6 pieces of touch keys disposed in the fourth to sixth rows of the keyboard 20 are selected in sequence, and the detections of the capacitance changes are performed.

As described above, the touch sensor of the embodiment performs the detections of the capacitance changes of the 36 pieces of touch keys 21 in sequence, thereby realizing decreasing the number of the channels (Ch6 to Ch11) and the number of the wires on the keyboard 2 (the drive lines 22-0 to 22-5 and the sensor lines 23-0 to 23-5). Furthermore, since the detections of the capacitance changes of the 36 pieces of touch keys 21 are performed respectively, the simultaneous touch operation of the plurality of touch keys 21 is also achieved.

It is noted that the number and position of the touch keys 21 on the keyboard 20 are changeable appropriately, and the structure of the sensor circuit 30 is also changeable accordingly.

===Example of Structure and Operation of Electric Charge Amplifier===

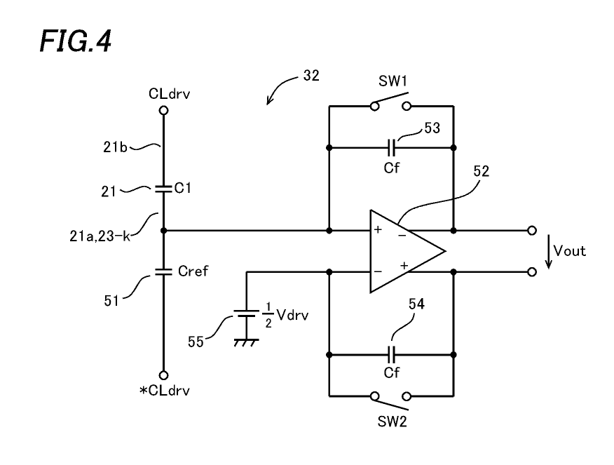

First, an example of a structure of the electric charge amplifier 32 will be described referring to FIG. 4. The electric charge amplifier 32 includes a reference electrostatic capacitor 51, a differential amplifier 52, a first feedback capacitor 53, a second feedback capacitor 54, a reference voltage source 55, a first switch SW1 and a second switch SW2.

Suppose that one touch key 21 is now selected, the clock signal CLdry is applied to the annular electrode 21b thereof, and the sensor line 23-k (k=0 to 5) connected to the center electrode 21a is selected by the selection circuit 31. The electrostatic capacitor having a capacitance C1 is formed between the center electrode 21a and annular electrode 21b of the touch key 21.

The reference electrostatic capacitor 51 has first and second terminals. The first terminal is connected to the sensor line 23-k selected by the selection circuit 31, and the inverted signal *Cdrv of the clock signal Cdrv is applied to the second terminal. The reference electrostatic capacitor 51 has a capacitance Cref.

The sensor line 23-k selected by the selection circuit 31 is connected to a non-inverting input terminal (+) of the differential amplifier 52. The reference voltage source 55 generates a reference voltage ½ Vdrv that is a difference voltage between the H level and L level of the clock signal CLdrv, i.e., a voltage of ½ of the amplitude Vdrv. This reference voltage ½ Vdry is applied to an inverting input terminal (−) of the differential amplifier 52.

The first switch SW1 and the first feedback capacitor 53 are connected in parallel between the non-inverting input terminal (+) and the inverting output terminal (−) of the differential amplifier 52. The second switch SW2 and the second feedback capacitor 54 are connected in parallel between the inverting input terminal (−) and the non-inverting output terminal (+) of the differential amplifier 52. Each of the first and second feedback capacitors 53 and 54 has a capacitance Cf.

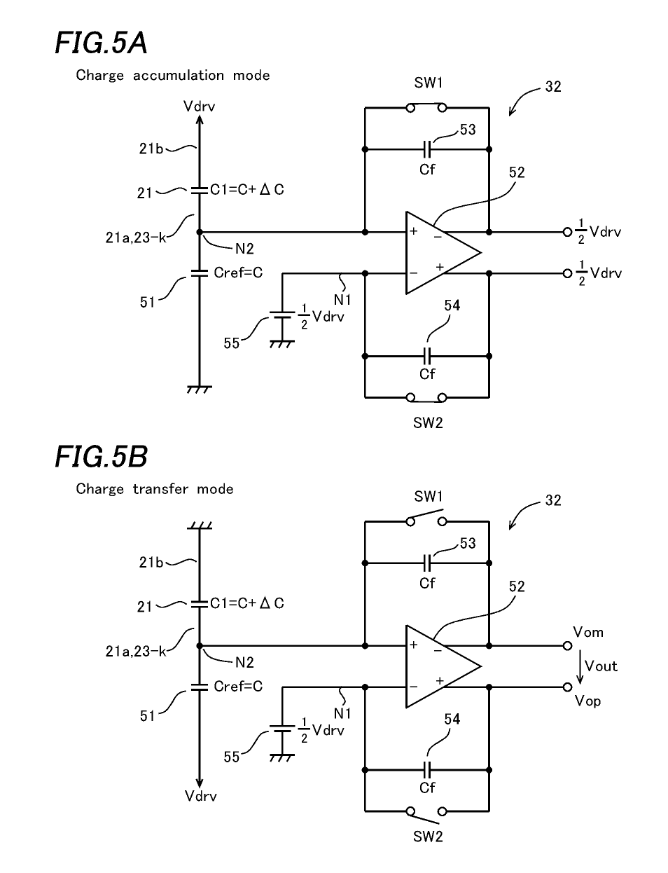

Next, an operation of the electric charge amplifier 32 will be described referring to FIGS. 5A and 5B. The electric charge amplifier 32 has two operation modes corresponding the H level and L level of the clock signal Cdrv, and these two operation modes are repeated alternately. The H level is Vdrv, and the L level is the ground voltage 0V. A voltage difference between an output voltage Vom from the inverting output terminal (−) of the differential amplifier 52 and an output voltage Vop from the non-inverting output terminal (+) of the differential amplifier 52 is an output voltage Vout (=Vop−Vom).

First, in a charge accumulation mode in FIG. 5A, the clock signal CLdry is H level (=Vdrv). Then the H level (=Vdrv) is applied to the annular electrode 21b of the electrostatic capacitor of the touch key 21. Furthermore, the L level (=0V) is applied to the second terminal of the reference electrostatic capacitor 55. Furthermore, in this mode, the switches SW1 and SW2 turn on. By this, the inverting output terminal (−) and the non-inverting input terminal (+) of the differential amplifier 52 are short-circuited, and the non-inverting output terminal (+) and the inverting input terminal (−) are short-circuited. As a result, the voltages of a node N1 (a node on the wire connected to the inverting input terminal (−)), a node N2 (a node on the wire connected to the non-inverting input terminal (+)), the inverting output terminal (−), the non-inverting output terminal (+) are set to ½ Vdrv, respectively.

Next, in a charge transfer mode in FIG. 5B, the clock signal CLdry is L level (=0V). Then the L level (0V) is applied to the annular electrode 21b of the electrostatic capacitor of the touch key 21, contrary to the charge accumulation mode. Furthermore, the H level (=Vdrv) is applied to the second terminal of the reference electrostatic capacitor 55. In this mode, the switches SW1 and SW2 turn off.

Suppose C1=Cref=C in the initial state in which a human finger or the like is in a distant position from the touch keys 21 where it does not influence the touch keys 21. Then, by touch with a human finger or the like, the capacitance C1 of the electrostatic capacitor changes by ΔC. It means that C1=C+ΔC and Cref=C.

In the charge accumulation mode in FIG. 5A, the amount of electric charge at the node N2 is given by the following equation.

The amount of electric charge at the node N2=(C+ΔC)·(−½Vdrv)+C(½Vdrv)+Cf·0 (1)

In the charge transfer mode in FIG. 5B, the amount of charge at the node N2 is given by the following equation.

The amount of electric charge at the node N2=(C+ΔC)·(½Vdrv)+C·(−½Vdrv)+Cf·(Vcom−½Vdrv) (2)

Equation (1)=Equation (2), since the amount of electric charge at the node N2 in the charge accumulation mode is equal to the amount of electric charge at the node N2 in the charge transfer mode according to the law of conservation of electric charge.

The following equation is obtained by solving Equation (1)=Equation (2) for Vom.

Vcom=(½−ΔC/Cf)·Vdrv (3)

Similarly, the following equation is obtained by applying the law of conservation of electric charge to the electric charges at the node N1 in the charge accumulation mode and in the charge transfer mode and solving the resulting equation for Vop.

Vop=½Vdrv (4)

Vout is obtained from Equation (3) and Equation (4).

Vout=Vop−Vom=ΔC/Cf·Vdrv (5)

Accordingly, it is understood that the output voltage Vout of the electric charge amplifier 32 varies proportionally to the amount of change ΔC of the electrostatic capacitor of the touch key 21. Although the calculation described above is performed under a condition C1=Cref=C in the initial state, when there is a difference between C1 and Cref in the initial state, Cref is adjustable using a calibration circuit so that the offset of the output voltage Vout becomes a predetermined value or a minimum value.

In the sensor circuit 30 described above, the electric charge amplifier 32 includes the reference electrostatic capacitor 51, and is configured so as to detect the amount of change ΔC of the capacitance C1 of the electrostatic capacitor formed between the center electrode 21a and the annular electrode 21b of the touch key 21 connected to one sensor line 23-k (k=0 to 5) selected by the selection circuit 31 and output an output voltage Vout proportional to AC. In other words, it employs a single detection method.

On the other hand, it may employ a differential detection method. In this case, the selection circuit 31 is configured so as to select two sensor lines, for example, adjacent sensor lines 23-k and 23-k+1 and detect a difference of the capacitances of the electrostatic capacitors of the touch keys 21 that are connected to the sensor lines 23-k and 23-k+1 respectively.

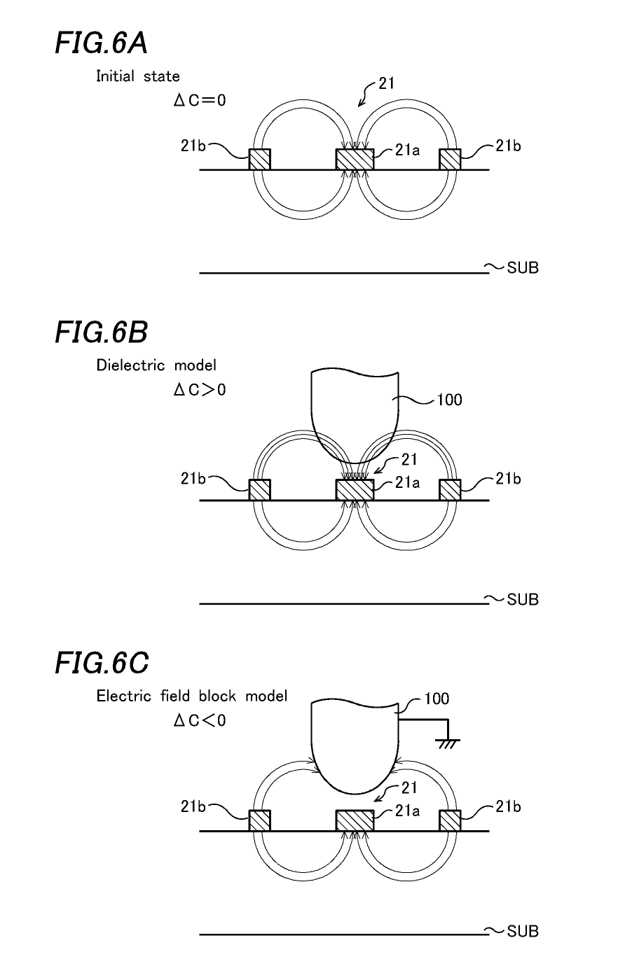

It is noted that the sign of the amount of change ΔC of the electrostatic capacitor of the touch key 21 differs depending on an electric model. This will be described referring to FIGS. 6A, 6B and 6C. FIGS. 6A, 6B and 6C are cross-sectional views of the touch keys 21. In the initial state in FIG. 6A, ΔC=0. FIG. 6B is a dielectric model in which a human finger or the like 100 is a dielectric. When a human finger or the like 100 comes close to the touch key 21, electric flux lines occurring between the center electrode 21a and the annular electrode 21b run through the human finger or the like 100, and thus the number of the lines increases. This results in increasing the capacitance of the electrostatic capacitor formed between the center electrode 21a and the annular electrode 21b of the touch key 21. In other words, ΔC>0 in this dielectric model.

On the other hand, FIG. 6C is an electric field block model in which a human finger or the like 100 is a grounded conductor. When the human finger or the like 100 comes close to the touch key 21, the number of electric flux lines occurring between the center electrode 21a and the annular electrode 21b decreases by an electric field blocking effect of the grounded human finger or the like 100. This result in decreasing the capacitance of the electrostatic capacitor formed between the center electrode 21a and the annular electrode 21b. In other words, ΔC<0 in this electric field block model.

===Other Example of Structure of Keyboard===

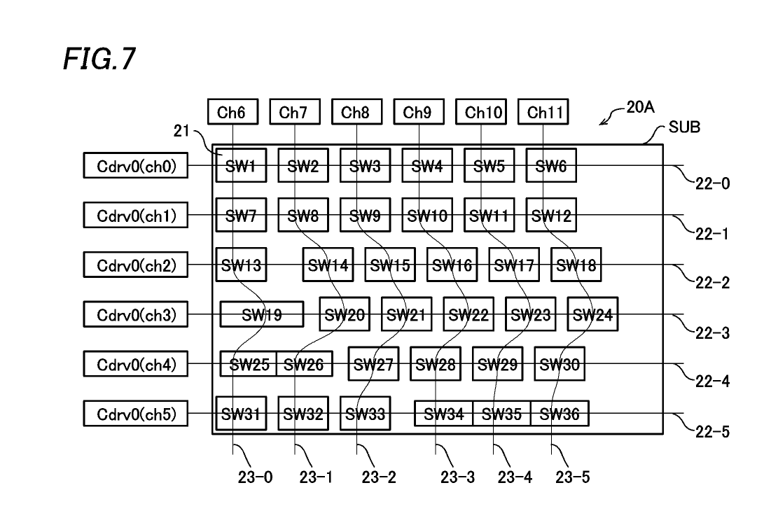

A keyboard 20A in FIG. 7 is configured so that 36 pieces of touch keys are disposed in 6 rows by 6 columns in the same manner as the keyboard 20 in FIG. 1. The 36 pieces of touch keys are given switch numbers of SW1 to SW36, respectively. All the touch keys 21 of the keyboard 20 in FIG. 1 have the same patterns, but the keyboard 20A in FIG. 7 includes touch keys having different patterns.

In detail, a touch key SW19 has larger size than the other touch keys SW1 and so on so as to be used as a large specific key such as a Shift key, a Space key or the like of a keyboard of a personal computer. Furthermore, the touch keys SW25 and SW26 are made by connecting the two touch keys 21 in FIG. 1 for the same purpose. In this case, a capacitance change of the electrostatic capacitor is detected by the two sensor lines 23-0 and 23-1. Furthermore, the touch keys SW34, SW35 and SW36 are made by connecting the three touch keys 21 in FIG. 1 for the same purpose. In this case, a capacitance change of the electrostatic capacitor is detected by the three sensor lines 23-3, 23-4 and 23-5.

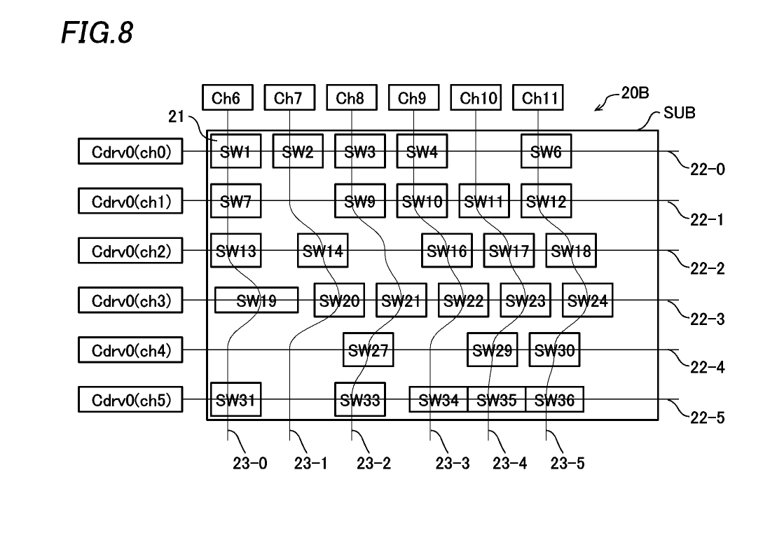

There is also a configuration in which some of the touch keys are removed from the keyboard 20 in FIG. 1. A keyboard 20B in FIG. 8 is an example of such a configuration of a keyboard, in which the 7 pieces of touch keys SW5, SW8, SW15, SW25, SW26, SW28 and SW32 are removed from the keyboard 20 in FIG. 1. In this case, the portions where the touch keys are removed do not function as touch keys.

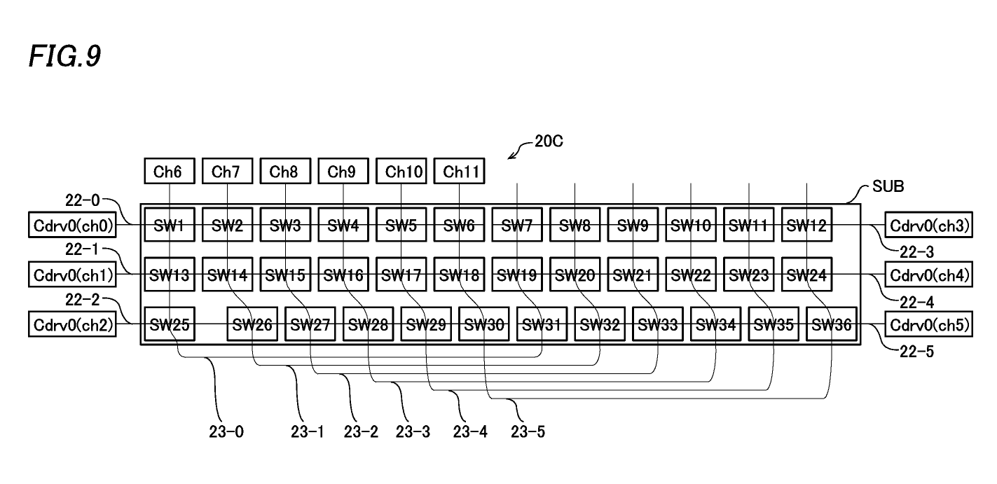

A keyboard 20C in FIG. 9 is configured so that the 36 pieces of touch keys 21 in FIG. 1 are disposed in 3 rows and 12 columns. The 36 pieces of touch keys are given switch numbers of SW1 to SW36, respectively. The disposition of the touch keys in the 3 rows and 6 columns on the left half of the keyboard 20C is the same as the disposition of the touch keys 21 on the upper half in FIG. 1. Furthermore, the disposition of the touch keys in the 3 rows and 6 columns on the right half of the keyboard 20C is the same as that of the touch keys 21 on the lower half in FIG. 1. An electric relation between the touch keys SW1 to SW36 and the drive lines 22-0 to 22-5 and an electric relation between the touch keys SW1 to SW36 and the sensor lines 23-0 to 23-5 are equivalent to those of the keyboard 20 in FIG. 1. It is noted that the number and position of the touch keys are not limited to the embodiment and modifications are possible appropriately.

===Example of Structure of Touch Key 21===

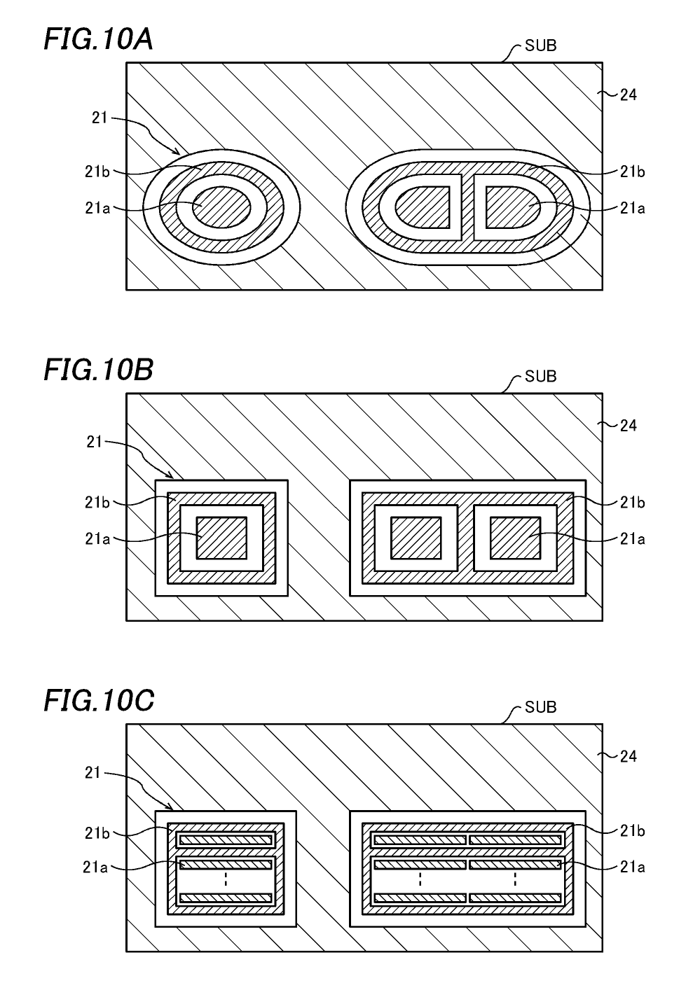

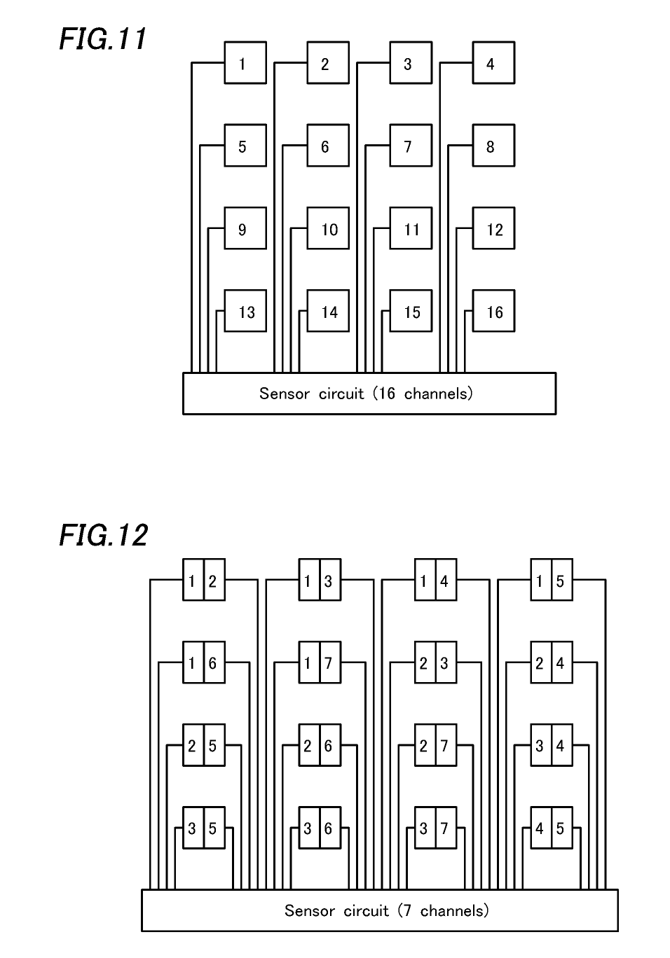

Next, examples of structures of the touch keys 21 disposed on the insulation substrate SUB will be described referring to FIGS. 10A, 10B and 10C. FIG. 10A shows round touch keys 21, FIG. 10B shows quadrate touch keys 21, and FIG. 10C shows comb-shaped touch keys 21. In FIGS. 10A, 10B and 10C, the touch key on the left side is a normal touch key 21, and the touch key on the right side is a large touch key 21 for a shift key or the like. The large touch key 21 is usable as the touch key SW25 and SW26 in FIG. 7.

First, in FIG. 10A, the normal touch key 21 has an oval center electrode 21a at the center, and an oval annular electrode 21b is disposed surrounding the center electrode 21a. The large touch key 21 has two almost oval center electrodes 21a, and an almost oval annular electrode 21b is disposed surrounding the two center electrodes 21a. In the large touch key 21, it is preferable that different sensor lines are connected to the two center electrodes 21a respectively. The center electrodes 21a and the annular electrode 21b may have a round shape.

In FIG. 10B, the normal touch key 21 has a quadrate center electrode 21a at the center, and a quadrate annular electrode 21b is disposed surrounding the center electrode 21a. The large touch key 21 has two quadrate center electrodes 21a, and a quadrate annular electrode 21b is disposed surrounding the two center electrodes 21a.

In FIG. 10C, the normal touch key 21 has an annular electrode 21b surrounding each of a plurality of oblong center electrodes 21a. The large touch key 21 forms an oblong shape as a whole by disposing two center electrodes 21a in each of regions surrounded by an annular electrode 21b.

Comparing the characteristics of the touch keys 21 in FIGS. 10A to 10C, the sensitivity reaches a peak at the center of the touch key 21 in FIG. 10A, and the proximity sensitivity, i.e., the detection sensitivity by the electric charge amplifier 32 when a human finger or the like comes close to the touch key 21 is high. The touch key 21 in FIG. 10B also has high proximity sensitivity, but a touch key 21 disposed close thereto may be influenced. The touch key 21 in FIG. 10C has relatively low proximity sensitivity, but the touch sensitivity, i.e., the detection sensitivity by the electric charge amplifier 32 when a human finger or the like touches the touch key 21 is high.

Furthermore, in the touch key 21 in FIGS. 10A, 10B and 10C, an influence of disturbance noise on the touch keys 21 is decreased by disposing a ground electrode 24 on the insulation substrate SUB on the outside of the annular electrodes 21b.

The invention decreases the numbers of channels and wires simultaneously. The invention also realizes a simultaneous touch operation of a plurality of touch keys.

What is claimed is:

1. A touch sensor comprising:
a substrate;
a plurality of touch keys disposed in a plurality of rows and columns on the substrate and each comprising a first electrode and a second electrode surrounding the first electrode;
a plurality of drive lines disposed on the substrate and each connecting the second electrodes of the plurality of touch keys disposed in a first direction corresponding to each of the plurality of rows;
a plurality of sensor lines disposed on the substrate and each connecting the first electrodes of the plurality of touch keys disposed in a second direction corresponding to each of the plurality of columns;
a clock source applying a clock signal to the plurality of drive lines in sequence;
a selection circuit selecting the plurality of sensor lines in sequence during the application of the clock signal to one of the plurality of drive lines from the clock source; and
a detection circuit detecting a change of a capacitance of an electrostatic capacitor formed between the first electrode and the second electrode of the touch key connected to the sensor line selected by the selection circuit.

2. The touch sensor of claim 1, wherein each of the first and second electrodes comprises a round shape.

3. The touch sensor of claim 1, wherein each of the first and second electrodes comprises a quadrate shape.

4. The touch sensor of claim 1, further comprising a ground electrode disposed on the substrate on the outside of the second electrode.

5. The touch sensor of claim 1,
the detection circuit comprising:
a reference electrostatic capacitor comprising first and second terminals, the first terminal being connected to the sensor line selected by the selection circuit and the second terminal being applied with an inverted signal of the clock signal;
a differential amplifier comprising a non-inverting input terminal, an inverting input terminal, a non-inverting output terminal and an inverting output terminal, the non-inverting input terminal being connected to the sensor line selected by the selection circuit and the inverting input terminal being applied with a voltage of ½ of a difference between a first level and a second level of the clock signal;
a first switch and a first feedback capacitor connected in parallel between the non-inverting input terminal and the inverting output terminal of the differential amplifier;
a second switch and a second feedback capacitor connected in parallel between the inverting input terminal and the non-inverting output terminal of the differential amplifier; and
a control circuit controlling the first and second switches so as to turn on the first and second switches during the first level of the clock signal and turn off the first and second switches during the second level of the clock signal,
wherein the detection circuit outputs an output voltage proportional to a change of the electrostatic capacitor from the non-inverting output terminal and the inverting output terminal.
